(19) United States
(12) Patent Application Publication
(10) Pub. No.: US 2016/0291734 A1
(43) Pub. Date: Oct. 6, 2016

(54) TOUCH CONTROL UNIT AND FABRICATING METHOD THEREOF

(71) Applicants: Boe Technology Group Co., Ltd., Beijing (CN); Beijing Boe Optoelectronics Technology Co., Ltd., Beijing (CN)

(72) Inventors: Jiuxia Yang, Beijing (CN); Feng Bai, Beijing (CN); Jiantao Liu, Beijing (CN)

(21) Appl. No.: 15/072,564

(22) Filed: Mar. 17, 2016

(30) Foreign Application Priority Data
Apr. 2, 2015 (CN) 201510155885.7

(51) Int. Cl. G06F 3/044

(52) U.S. Cl. CPC G06F 3/044; G06F 2203/04103; G06F 2203/04102

(57) ABSTRACT

The embodiments of the present invention provide a touch control unit and fabricating method thereof as well as a flexible touch control display device. The touch control unit comprises at least one layer of modified carbon nanotube film, wherein the modified carbon nanotube film is obtained from modification of a carbon nanotube by a strongly oxidizing material.

### RELATED APPLICATIONS

This application claims priority to Chinese Application Serial No. 201510155885.7, filed on Apr. 2, 2015, the entire disclosure of which is incorporated herein by reference.

### FIELD OF THE INVENTION

This disclosure relates to the field of new material production, particularly to a touch control unit and a fabricating method thereof as well as a touch control display device.

### BACKGROUND OF THE INVENTION

The touch control unit in the related art is fabricated using transparent electrical conductive materials such as ITO (tin indium oxide). Generally, however, these materials have relatively bad mechanical strength and flexibility, which determines that the touch control unit fabricated by these materials cannot be applied into the flexible display product perfectly.

Although carbon nanotube materials have good mechanical property and flexibility, since the conductivity and square resistance of the carbon nanotube itself cannot meet the performance requirement of the touch control unit, the carbon nanotube material cannot be applied into the flexible display product perfectly.

Therefore, it is required to design a new touch control unit structure so as to enable it to apply the mechanical property and flexibility of the carbon nanotube material and overcome the defect that the conductivity and square resistance of the carbon nanotube itself cannot meet the performance requirement of the touch control unit.

### SUMMARY OF THE INVENTION

Some embodiments of the present invention provide a touch control unit and a fabricating method thereof, as well as a flexible touch control display device.

In a first aspect, the disclosure provides a touch control unit, comprising at least one layer of modified carbon nanotube film, wherein the modified carbon nanotube film is obtained from modification of a carbon nanotube by a strongly oxidizing material.

The strongly oxidizing material may include nitrogen dioxide, Br₂, nitric acid, thionyl chloride, perfluorosulfonic acid and/or tetrafluorotetracyanoquinodimethane.

The touch control unit may further comprise a protective layer arranged on the layer of the modified carbon nanotube film.

The protective layer may be formed by an electrical conductive polymer material.

The protective layer may be formed by the electrical conductive polymer material added with gold nanoballs or silver nanowires.

The protective layer may be formed by coating the electrical conductive polymer material in a solution form.

The electrical conductive polymer material may include: polyacetylene, polythiophene, polypyrrole, polyaniline, polyphenylene, polyphenylene ethyne and/or polydiacetylene.

In a second aspect, the disclosure provides a touch control substrate, comprising a base substrate on which a touch control unit stated above is arranged.

The touch control substrate may comprise multiple layers of touch control units, and an insulating layer may be arranged between every two layers of touch control units.

In a third aspect, the disclosure provides a touch control display device, comprising a touch control substrate stated above.

The touch control substrate may be arranged in a bending or folding state, at least one touch control unit on the touch control substrate is located in a non-display area.

In a fourth aspect, the disclosure provides a fabricating method of a touch control unit, comprising:

forming at least one layer of carbon nanotube film;

performing modification treatment to the carbon nanotube film using a strongly oxidizing material to obtain a modified carbon nanotube film; and

forming an electrode pattern on the modified carbon nanotube film to obtain a modified carbon nanotube film with the electrode pattern.

The strongly oxidizing material may include nitrogen dioxide, Br₂, nitric acid, thionyl chloride, perfluorosulfonic acid and/or tetrafluorotetracyanoquinodimethane.

The fabricating method of a touch control unit may further comprise:

forming a protective layer on the modified carbon nanotube film with the electrode pattern; or, forming a protective layer on the modified carbon nanotube film before forming the electrode pattern on the modified carbon nanotube film.

The protective layer may be formed by an electrical conductive polymer material.

The protective layer may be formed by the electrical conductive polymer material added with gold nanoballs or silver nanowires.

The protective layer may be formed by coating the electrical conductive polymer material in a solution form.

The electrical conductive polymer material may include: polyacetylene, polythiophene, polypyrrole, polyaniline, polyphenylene, polyphenylene ethyne and/or polydiacetylene.

Performing modification treatment to the carbon nanotube film using a strongly oxidizing material may comprise: placing the carbon nanotube film in a nitric acid solution for 5 min˜30 min and then taking the carbon nanotube film out; and cleaning and drying the carbon nanotube film that has been treated by the nitric acid solution.

Performing modification treatment to the carbon nanotube film using a strongly oxidizing material may comprise: spraying a nitric acid solution onto the carbon nanotube film and placing the carbon nanotube film for 5 min˜30 min; and cleaning and drying the carbon nanotube film that has been treated by the nitric acid solution.

The carbon nanotube film that has been treated by the nitric acid solution may be cleaned using deionized water.

The cleaned carbon nanotube film may be dried by air-drying, baking or placing to dry.

From the above technical solution it can be seen that in the touch control unit according to the embodiment of the present invention, by performing modification treatment to the nanotube which has better mechanical property and flexibility essentially, the touch control unit fabricated by the modified nanotube is enabled to further have characteristics of high conductivity and low square resistance in addition to maintaining good mechanical property and flexibility, thereby meeting the performance requirement of the touch control unit, so that the touch control unit fabricated by the modified nanotube can be applied into the flexible touch control or flexible display product perfectly.

In addition, the touch control unit according to the embodiment of the present invention saves cost relative to the touch control unit fabricated by using other flexible materials such as graphene because it uses the carbon nanotube material which has a relatively low price.

The touch control unit according to the embodiment of the present invention has excellent mechanical strength and flexibility, so that the touch control unit can be arranged on several adjacent surfaces (such as side surface and back surface) of the touch control panel successively, thereby overcoming the defect in the prior art that the touch control unit can only be arranged on the main display panel, i.e., the application of the touch control unit according to the embodiment of the present invention can realize expansion of the touch control area of the display device. Meanwhile, the display device fabricated by the touch control unit according to the embodiment of the present invention can cooperate with the internal system program of the display device to implement certain instruction operations of the display device without lighting up the screen, hence, the energy consumption is saved, so as to enable the endurance ability of the display device to be prolonged.

### BRIEF DESCRIPTION OF THE DRAWINGS

In order to explain the technical solutions in the embodiments of the present invention or the prior art more clearly, next, the drawings to be used in describing the embodiments or the prior art will be introduced briefly. The drawings described below and accompanying this disclosure only show some embodiments of the present invention. Other drawings can also be obtained from these drawings for the ordinary skilled person in the art, on the premise of paying no creative work.

FIG. 1 and FIG. 2 are schematic views of two structures of a touch control unit provided by a first embodiment of the present invention;

FIG. 3 is a structural schematic view of a touch control unit provided by a second embodiment of the present invention;

FIG. 4 is a structural schematic view of a touch control unit provided by a third embodiment of the present invention;

FIG. 5 is a structural schematic view of another touch control unit provided by the third embodiment of the present invention;

FIG. 6 is a structural schematic view of a touch control substrate provided by a fourth embodiment of the present invention;

FIG. 7 is a flow chart of a fabricating method of a touch control unit provided by a sixth embodiment of the present invention;

FIG. 8 is a flow chart of a fabricating method of a touch control unit provided by a seventh embodiment of the present invention.

### DETAILED DESCRIPTION OF THE INVENTION

In order to enable the purposes, technical solutions and advantages of the embodiments of the present invention to be clearer, next, the technical solutions in the embodiments of the present invention will be described clearly and completely with reference to the drawings in the embodiments of the present invention. Apparently, the embodiments described are only a part of rather than all of the embodiments of the present invention. Based on the embodiments described below, all other embodiments obtained by the ordinary skilled person in the art on the premise of paying no creative work belong to the protection scope of the present invention.

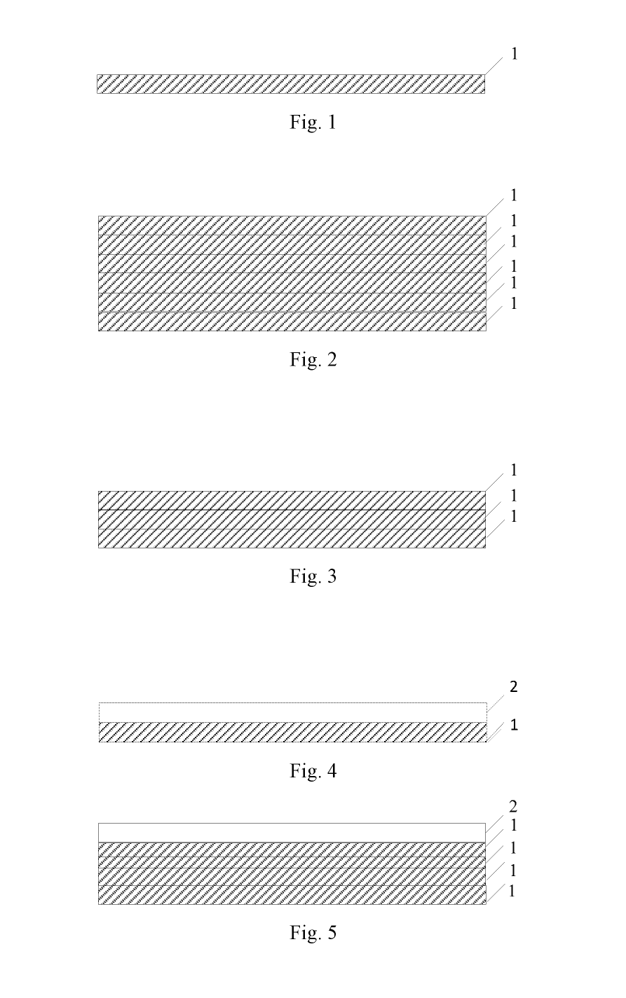

FIG. 1 and FIG. 2 show structural schematic views of a touch control unit provided by an embodiment of the present invention. As shown in FIG. 1 and FIG. 2, the touch control unit provided by this embodiment comprises at least one layer of modified carbon nanotube film 1, the modified carbon nanotube film 1 is obtained from modification of a carbon nanotube by a strongly oxidizing material, the modified carbon nanotube film 1 has high conductivity and low square resistance.

In one example of this embodiment, referring to FIG. 1, the touch control unit comprises one layer of modified carbon nanotube film 1. In the other example of this embodiment, referring to FIG. 2, the touch control unit comprises six layers of modified carbon nanotube film 1, the thickness of the six layers of modified carbon nanotube film 1 may be either same or different. FIG. 2 gives the example that the thickness of each layer is the same. In actual application of the touch control unit, modified carbon nanotube films of different number of layers and thickness can be designed based on actual needs.

The touch control unit provided by this embodiment, by performing modification treatment to the nanotube which has better mechanical property and flexibility essentially, enables the touch control unit fabricated by the modified nanotube to further have characteristics of high conductivity and low square resistance in addition to maintaining good mechanical property and flexibility, thereby meeting the performance requirement of the touch control unit, so that the touch control unit fabricated by the modified nanotube can be applied into the flexible touch control or flexible display product perfectly.

In addition, the touch control unit provided by this embodiment saves cost relative to the touch control unit fabricated by using other flexible materials such as graphene because it uses the carbon nanotube material which has a relatively low price.

Since the touch control unit provided by this embodiment has excellent mechanical strength and flexibility, the touch control unit can be arranged on several adjacent surfaces (such as side surface and back surface) of the touch control panel successively, thereby overcoming the defect in the prior art that the touch control unit can only be arranged on the main display panel, i.e., the application of the touch control unit in this embodiment can realize expansion of the touch control area of the display device. Meanwhile, the display device fabricated by the touch control unit of this embodiment can cooperate with the internal system program of the display device to implement certain instruction operations of the display device without lighting up the screen. Hence, the energy consumption is saved, so as to enable the endurance ability of the display device to be prolonged.

Referring to FIG. 3, the touch control unit provided by a second embodiment of the present invention comprises three layers of modified carbon nanotube film 1. The modified carbon nanotube film 1 is obtained from modification of a carbon nanotube by a strongly oxidizing material. The modified carbon nanotube film 1 has high conductivity and low square resistance.

Since the conductivity and square resistance of the carbon nanotube itself cannot meet the performance requirement of touch control, it needs to be modified so as to enable its performance to meet the touch control requirement. This embodiment, by performing modification process to the carbon nanotube film, enables it to meet the requirement. The modification process of this embodiment performs modification treatment to the carbon nanotube film using a strongly oxidizing material (such as NO₂, Br₂, HNO₃, SOCl₂, Nafion and/or TCNQF4), the conductivity of the modified carbon nanotube can reach 12000 s/cm˜90000 s/cm, and the square resistance can reach 10Ω/□.

The touch control unit provided by this embodiment, by performing modification treatment to the nanotube which has better mechanical property and flexibility essentially, enables the touch control unit fabricated by the modified nanotube to further have characteristics of high conductivity and low square resistance in addition to maintaining good mechanical property and flexibility, thereby meeting the performance requirement of the touch control unit, so that the touch control unit fabricated by the modified nanotube can be applied into the flexible touch control or flexible display product perfectly.

A third embodiment provides a touch control unit. The touch control unit comprises at least one layer of modified carbon nanotube film, the modified carbon nanotube film is obtained from modification of a carbon nanotube by a strongly oxidizing material, the touch control unit further comprises a protective layer arranged on the layer of the modified carbon nanotube film. Referring to FIGS. 4 and 5, the touch control unit as shown in FIG. 4 comprises one layer of modified carbon nanotube film 1 and one layer of protective layer 2, the touch control unit as shown in FIG. 5 comprises four layers of modified carbon nanotube film 1 arranged successively with mutually different thickness and one layer of protective layer 2.

The touch control unit of this embodiment adds a protective layer 2 on the modified carbon nanotube film 1 on the basis of the above embodiments, because the carbon nanotube structure after surface modification has a relatively bad stability, particularly when it is exposed in solvent conditions such as acidity, alkalinity and under environment conditions of high temperature, high humidity, UV presence. This causes the modified carbon nanotube structure to be unsatisfactory in electrical performance. Therefore, in order to meet its requirements of stability and reliability, this embodiment designs a layer of protective layer on the modified carbon nanotube film. The function of the protective layer is enabling the electrical performance of the modified carbon nanotube film to be stable, thereby meeting the reliability requirements for long term stability.

In order to meet the requirement for long term stability of the electrical performance of the modified carbon nanotube, the protective layer for example can be an electrical conductive polymer protective layer, i.e., the protective layer is formed by an electrical conductive polymer material. Generally, the electrical conductive polymer material can include: polyacetylene, polythiophene, polypyrrole, polyaniline, polyphenylene, polyphenylene ethyne and/or polydiacetylene.

In an optional example of this embodiment, the electrical conductive polymer material is provided with gold nanoballs or silver nanowires, thereby enabling the touch control unit with a protective layer formed by this material to have a higher stability.

In another example of this embodiment, the protective layer is formed by coating the electrical conductive polymer material in a solution form. That is, prior to forming the protective layer of the carbon nanotube, the electrical conductive polymer material to be used needs to form a solution. This embodiment uses ion liquid as the solvent of the electrical conductive polymer.

The ion liquid for fabricating the electrical conductive polymer solution in this embodiment includes: ion liquid at room temperature such as 1-ethyl-3-methylimidazolium hexafluorophosphate ([emim] PF6), 1-butyl-3-methylimidazolium hexafluorophosphate ([bmim] PF6), 1-octyl-3-methylimidazolium hexafluorophosphate ([omim] PF6), 1-ethyl-3-methylimidazolium tetrafluoroborate ([emim]BF4), 1-butyl-3-methylimidazolium trifluoromethylsulfonate ([bmim]CF3S03), 1-butyl-3-methylimidazolium chloride ([bmim]Cl), specifically it may be one or more of the above ion liquid.

Fabricating the protective layer by coating the electrical conductive polymer solution can make the fabrication of the protective layer simpler and more convenience for industrial production.

The touch control unit of this embodiment comprises a layer of modified carbon nanotube film and a protective layer, the modified carbon nanotube film, in addition to maintaining good mechanical property and flexibility of the carbon nanotube, further has the characteristics of high conductivity and low square resistance, which meets the performance requirement of the touch control unit; the protective layer protects the modified and unstable carbon nanotube film from being influenced by external environment of acidity-alkalinity, high temperature, high humidity, UV light, so as to enable the modified carbon nanotube to have stable electrical performance, thereby enabling the whole touch control unit to meet reliability requirements for long term stability. The touch control unit of this embodiment can be applied in various types of touch control panels, such as: it can be applied in products of On-cell, In-cell, Out-cell and OGS (OneGlassSolution).

A fourth embodiment provides a touch control substrate comprising a base substrate, on which the touch control unit according to one or more of the previous embodiments is arranged.

Optionally, when the touch control substrate needs to arrange multiple layers of touch control unit, an insulating layer needs to be arranged between every two layers of touch control unit.

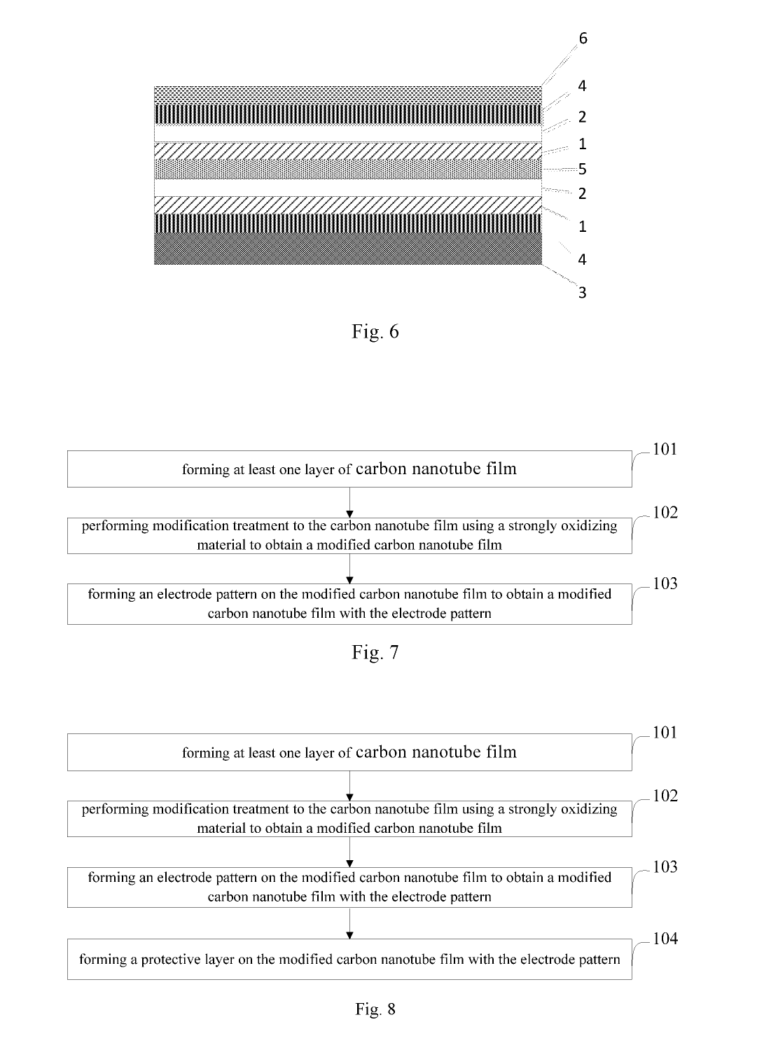

FIG. 6 is a structural schematic view of a touch control substrate provided by a fourth embodiment of the present invention. Wherein 1 represents modified carbon nanotube film, 2 represents protective layer, 3 represent base substrate, 4 represents optically transparent resin OCR or optically transparent adhesive OCA, 5 represents insulating layer, 6 represents an upmost layer of isolation protective layer on the touch control substrate.

The touch control substrate as shown in FIG. 6 arranges two layers of touch control unit, an insulating layer 5 is arranged between two layers of touch control unit. Wherein the two layers of touch control unit in FIG. 6 both comprise one layer of modified carbon nanotube film 1 and one layer of protective layer 2.

The touch control substrate of this embodiment comprises the touch control unit of the above third embodiment, hence, the touch control substrate of this embodiment has the beneficial effect of the above third embodiment.

A fifth embodiment provides a touch control display device comprising the touch control substrate of the fourth embodiment. The touch control substrate can be arranged in a bending or folding state, at least one touch control unit on the touch control substrate is located in a non-display area, i.e., the touch control unit can be arranged at the side surface, back surface or the non-display portion of the surface where the display area locates of the touch control display device.

The touch control display device of this embodiment comprises the touch control substrate of the above fourth embodiment. Hence, it has the same beneficial effect as the fourth embodiment. In addition, the touch control display device of this embodiment can comprise one or more touch control substrates of the fourth embodiment, the touch control substrate can be arranged on any surface or several continuous surfaces of the touch control display device in a bending or folding form.

FIG. 7 shows a flow chart of a fabricating method of a touch control unit provided by a sixth embodiment, the touch control unit can be the touch control unit of the above first or second embodiment. Referring to FIG. 7, the fabricating method of the touch control unit comprises:

Step 101: forming at least one layer of carbon nanotube film.

In this step, the carbon nanotube film can be formed by coating a carbon nanotube dispersion and then curing it; and the carbon nanotube film can also be formed by stretching the film, i.e., by stretching and curing the film directly; wherein the number of layers of the carbon nanotube film can be set based on actual needs.

Step 102: performing modification treatment to the carbon nanotube film using a strongly oxidizing material to obtain a modified carbon nanotube film.

In this step, a strongly oxidizing material e.g. nitric acid can be used to perform modification treatment to the carbon nanotube film:

placing the carbon nanotube film in a nitric acid HNO₃ solution for 5 min˜30 min and then taking the carbon nanotube film out;

cleaning and drying the carbon nanotube film that has been treated by the HNO₃.

Or the treatment can be performed in another manner as follows:

spraying a nitric acid, HNO₃, solution onto the carbon nanotube film and placing the carbon nanotube film for 5 min˜30 min;

cleaning and drying the carbon nanotube film that has been treated by the HNO₃.

Certainly, other strongly oxidizing materials such as thionyl chloride (SOCl₂), Nafion can also be used to perform modification treatment to the carbon nanotube film.

When cleaning and drying the carbon nanotube film that has been treated by the HNO₃, specifically, the carbon nanotube film that has been treated by the HNO₃ can be cleaned by using deionized water, and the cleaned carbon nanotube film can be dried by air-drying, baking or placing to dry.

The modified carbon nanotube film after the treatment of this step has high conductivity and low square resistance.

Step 103: forming an electrode pattern on the modified carbon nanotube film to obtain a modified carbon nanotube film with the electrode pattern.

In this embodiment, the step 102 and the step 103 can be interchanged, i.e., the electrode pattern can be formed on the carbon nanotube film firstly, and then modification treatment is performed to the carbon nanotube film with the electrode pattern, the specific modification treatment process is similar, which will not be repeated here.

The touch control unit formed by using the method of this embodiment, in addition to maintaining good mechanical property and flexibility of the carbon nanotube, further has the characteristics of high conductivity and low square resistance, which meets the performance requirement of the touch control unit, hence, the touch control unit can be applied in the flexible touch control or flexible display device perfectly.

In addition, the touch control unit formed by using the method of this embodiment saves cost relative to the touch control unit fabricated by using other flexible materials such as graphene because it uses the carbon nanotube material which has a relatively low price.

The touch control unit formed by using the method of this embodiment has excellent mechanical strength and flexibility, so that the touch control unit can be arranged on several adjacent surfaces (such as side surface and back surface) of the touch control panel successively, thereby overcoming the defect in the prior art that the touch control unit can only be arranged on the main display panel, i.e., the application of the touch control unit formed by using the method of this embodiment can realize expansion of the touch control area of the display device. Meanwhile, the display device fabricated by the touch control unit of this embodiment can cooperate with the internal system program of the display device to implement certain instruction operations of the display device without lighting up the screen. Hence, the energy consumption is saved, so as to enable the endurance ability of the display device to be prolonged.

FIG. 8 shows a flow chart of a fabricating method of a touch control unit provided by a seventh embodiment, this touch control unit is the touch control unit of the above third embodiment. Referring to FIG. 8, the fabricating method of the touch control unit in this embodiment is similar as the steps of the above sixth embodiment, the difference only lies in that the fabricating method of the touch control unit in this embodiment, on the basis of sixth embodiment, further comprises:

Step 104: forming a protective layer on the modified carbon nanotube film with the electrode pattern.

The protective layer is arranged on the modified carbon nanotube film because:

The carbon nanotube structure after surface modification has a relatively bad stability, particularly when it is exposed in solvent conditions such as acidity, alkalinity and under environment conditions of high temperature, high humidity, UV presence, thereby causing the modified carbon nanotube structure unsatisfactory in electrical performance. Therefore, in order to meet its requirements of stability and reliability, this embodiment arranges a layer of protective layer on the modified carbon nanotube film. The function of the protective layer is enabling the electrical performance of the modified carbon nanotube film to be stable, thereby meeting the reliability requirements for long term stability.

In the implementing process of this embodiment, in addition to forming a protective layer on the modified carbon nanotube film with the electrode pattern, the process order for arranging the protective layer can be also adjusted, i.e., the protective layer can also be arranged before step 103:

That is, prior to forming an electrode pattern on the modified carbon nanotube film, arranging a protective layer on the modified carbon nanotube film, and then forming the electrode pattern.

In order to meet the requirement for long term stability of the electrical performance of the modified carbon nanotube, the protective layer is formed by an electrical conductive polymer protective layer. Generally, the electrical conductive polymer material can include: polyacetylene, polythiophene, polypyrrole, polyaniline, polyphenylene, polyphenylene ethyne and/or polydiacetylene.

In an optional example of this embodiment, the electrical conductive polymer material is provided with gold nanoballs or silver nanowires, thereby enabling the touch control unit with a protective layer formed by this material to have a higher stability.

In another example of this embodiment, the protective layer is formed by coating the electrical conductive polymer material in a solution form. That is, prior to forming the protective layer of the carbon nanotube, the electrical conductive polymer material to be used needs to be treated in a solution form. This embodiment uses ion liquid as the solvent of the electrical conductive polymer.

The ion liquid for fabricating the electrical conductive polymer solution in this embodiment includes: ion liquid at room temperature such as 1-ethyl-3-methylimidazolium hexafluorophosphate ([emim] PF6), 1-butyl-3-methylimidazolium hexafluorophosphate ([bmim] PF6), 1-octyl-3-methylimidazolium hexafluorophosphate ([omim] PF6), 1-ethyl-3-methylimidazolium tetrafluoroborate ([emim]BF4), 1-butyl-3-methylimidazolium trifluoromethylsulfonate ([bmim]CF3S03), 1-butyl-3-methylimidazolium chloride ([bmim]Cl), specifically it may be one or more of the above ion liquid.

Fabricating the protective layer by coating the electrical conductive polymer solution can make the fabrication of the protective layer simpler and more convenience for industrial production.

The fabricating method of the touch control unit of this embodiment arranges a protective layer on the modified carbon nanotube film, the function of the protective layer is enabling the electrical performance of the modified carbon nanotube film to be stable, thereby meeting the reliability requirements for long term stability.

The above embodiments are only used for explaining rather than limiting the technical solutions of the present invention; although the present invention has been explained in detail with reference to the preceding embodiments, the ordinary skilled person in the art should understand that: he/she can still make modifications to the technical solutions stated by the preceding embodiments or make equivalent replacements to part of the technical features therein; however, these modifications or replacements do not cause the essence of the corresponding technical solutions to depart from the spirit and the scope of the technical solutions of the embodiments of the present invention.

1. A touch control unit, comprising at least one layer of modified carbon nanotube film, wherein the modified carbon nanotube film is obtained from modification of a carbon nanotube by a strongly oxidizing material.

2. The touch control unit according to claim 1, wherein the strongly oxidizing material includes at least one of nitrogen dioxide, Br₂, nitric acid, thionyl chloride, perfluorosulfonic acid, and tetrafluorotetracyanoquinodimethane.

3. The touch control unit according to claim 1, wherein the touch control unit further comprises a protective layer arranged on the layer of the modified carbon nanotube film.

4. The touch control unit according to claim 3, wherein the protective layer is formed by an electrical conductive polymer material.

5. The touch control unit according to claim 4, wherein the protective layer is formed by the electrical conductive polymer material added with gold nanoballs or silver nanowires.

6. The touch control unit according to claim 4, wherein the protective layer is formed by coating the electrical conductive polymer material in a solution form.

7. The touch control unit according to claim 4, wherein the electrical conductive polymer material includes at least one of polyacetylene, polythiophene, polypyrrole, polyaniline, polyphenylene, polyphenylene ethyne, and polydiacetylene.

8. A touch control substrate, comprising a base substrate on which a touch control unit according to claim 1 is arranged.

9. The touch control substrate according to claim 8, wherein the touch control substrate comprises multiple layers of touch control units, an insulating layer is arranged between every two layers of touch control units.

10. A fabricating method of a touch control unit, comprising:
forming at least one layer of carbon nanotube film;
performing modification treatment to the carbon nanotube film using a strongly oxidizing material to obtain a modified carbon nanotube film; and
forming an electrode pattern on the modified carbon nanotube film to obtain a modified carbon nanotube film with the electrode pattern.

11. The fabricating method of a touch control unit according to claim 10, wherein the strongly oxidizing material includes at least one of nitrogen dioxide, Br₂, nitric acid, thionyl chloride, perfluorosulfonic acid, and tetrafluorotetracyanoquinodimethane.

12. The fabricating method of a touch control unit according to claim 10, further comprising:
forming a protective layer on the modified carbon nanotube film with the electrode pattern.

13. The fabricating method of a touch control unit according to claim 12, wherein the protective layer is formed by an electrical conductive polymer material.

14. The fabricating method of a touch control unit according to claim 13, wherein the protective layer is formed by the electrical conductive polymer material added with gold nanoballs or silver nanowires.

15. The fabricating method of a touch control unit according to claim 13, wherein the protective layer is formed by coating the electrical conductive polymer material in a solution form.

16. The fabricating method of a touch control unit according to claim 13, wherein the electrical conductive polymer material includes at least one of polyacetylene, polythiophene, polypyrrole, polyaniline, polyphenylene, polyphenylene ethyne, and polydiacetylene.

17. The fabricating method of a touch control unit according to claim 10, wherein performing modification treatment to the carbon nanotube film using a strongly oxidizing material comprises:
placing the carbon nanotube film in a nitric acid solution for 5 min˜30 min and then taking the carbon nanotube film out; and
cleaning and drying the carbon nanotube film that has been treated by the nitric acid solution.

18. The fabricating method of a touch control unit according to claim 10, wherein performing modification treatment to the carbon nanotube film using a strongly oxidizing material comprises:
spraying a nitric acid solution onto the carbon nanotube film and placing the carbon nanotube film for 5 min˜30 min; and
cleaning and drying the carbon nanotube film that has been treated by the nitric acid solution.

19. The fabricating method of a touch control unit according to claim 17, wherein the carbon nanotube film that has been treated by the nitric acid solution is cleaned using deionized water.

20. The fabricating method of a touch control unit according to claim 17, wherein the cleaned carbon nanotube film is dried by air-drying, baking or placing to dry.

21. The fabricating method of a touch control unit according to claim 10, further comprising:
forming a protective layer on the modified carbon nanotube film before forming the electrode pattern on the modified carbon nanotube film.
